(19) United States
(12) Patent Application Publication
(10) Pub. No.: US 2025/0283859 A1
(43) Pub. Date: Sep. 11, 2025

(54) PORTABLE ULTRA PERFORMANCE LIQUID CHROMATOGRAPHY

(71) Applicants: Ju Yao Chang, Taipei (TW); Jung Lee Lin, Taipei (TW); Chung Hsuan Chen, Knoxville, TN (US)

(72) Inventors: Ju Yao Chang, Taipei (TW); Jung Lee Lin, Taipei (TW); Chung Hsuan Chen, Knoxville, TN (US)

(73) Assignee: i Analyzer Inc., Taipei (TW)

(21) Appl. No.: 18/600,814

(22) Filed: Mar. 11, 2024

(51) Int. Cl. G01N 30/74; B01D 15/14; B01D 15/42; G01N 30/02; G01N 30/72

(52) U.S. Cl. CPC G01N 30/74; B01D 15/14; B01D 15/424; G01N 30/7233; G01N 2030/027

(57) ABSTRACT

An UPLC can offer the advantages of improved resolution, shorter analysis time, reduced solvent consumption, and easy connectivity to a mass spectrometer. One of our unique approaches is to use four small linear pumps to achieve gradient elution. We use four binary pumps to achieve continuous gradient elution. We designed an on-line degassing to greatly reduce interference from gas bubbles, thereby maintaining stable pressure. The range of flow speed is controlled from 300 nl/min to 100 ul/min. This portable UPLC can withstand pressures of 15,000 psi or higher. Its size is 30 cm×30 cm×30 cm, and it weighs less than 20 kg. This portable UPLC is equipped with an LED detector, which reduces both cost and system size and has higher sensitivity than a spectrophotometer. We also have the option to easily switch to a conventional detector with a discharge light source and a grating spectrophotometer.

### TECHNICAL FIELD OF THE INVENTION

This invention is a Portable Ultra Performance Liquid Chromatography (pUPLC) designed to be small in size and light in weight, making it easy to carry. Its specific features include a broad range of elution speeds, a step-motor system to keep the mobile phase stable, an on-line degas system to greatly reduce gas bubble formation, and an LED detector to increase sensitivity while also reducing the size and cost of the detector.

### BACKGROUND OF THE INVENTION

Liquid chromatography is a common technique used for the chemical separation of sample with mixtures of compounds. Samples are introduced into a column by a carrier (mobile phase) that flows through a stationary phase composed of particles.

In conventional high performance liquid chromatography (HPLC), the instrument can only withstand pressures up to ˜6000 psi. Ultra performance liquid chromatography (UPLC) was developed to overcome this pressure barrier.

Most commercial UPLCs can withstand pressures higher than 10,000 psi. It offers the advantages of improved resolution, shorter analysis time, reduced solvent consumption, and easy connectivity to a mass spectrometer for the analysis of eluted compounds. UPLC has only been utilized in laboratory settings and not in the field. This invention aims to overcome these barriers and make a portable UPLC system feasible.

The range of flow speed of this UPLC is controlled from 300 nl/min to 100 μl/min. It can withstand pressures of 15,000 psi or higher. Its size is 30 cm×30 cm×30 cm, and it weighs less than 20 kg. It meets most detection criteria listed for tabletop UPLCs, in addition to being portable.

### 1. Basic of HPLC and UPLC

When chemicals dissolved in the mobile phase pass through the stationary phase, the interaction of each chemical with the stationary phase is different. Therefore, the retention time for various chemicals in the stationary phase is different. High-performance liquid chromatography (HPLC) uses a high-pressure infusion system, where mobile phases such as solvents are typically pumped into a column equipped with tiny particles as a stationary phase. After the chemicals in the column are separated, they enter the detector to be analyzed. HPLC has the features of high analysis speed, good sensitivity, and can analyze and separate various compounds.

There are two major different elution methods that include (1) isocratic and (2) gradient elution. In isocratic HPLC, the analytes move at a speed depending on the partition coefficient of the analyte between the mobile and stationary phase. Isocratic elution has the disadvantage of poor resolution, especially for samples with a broad range of hydrophobicity. Gradient HPLC typically provides better resolution and can cope with a broad range of hydrophobicity. Gradient elution usually involves the online mixing of solvents to achieve a steady increase in one solvent to increase the elution strength. Nevertheless, isocratic elution has the advantage of simplicity. It is better to equip both isocratic and gradient elution in the same device.

Ultrahigh-pressure liquid chromatography or Ultra-performance liquid chromatography (UPLC) was introduced to overcome the pressure limitations of conventional HPLC and to allow the use of very tiny particles as stationary phases.¹⁻³ UPLC has become a popular analytical tool due to its super separation, short analysis time and low solvent consumption. Tiny particles with diameter less than 2 μm can improve LC performance. However, the use of small particles requires high pressures to maintain the same separation efficiency with the same column length. Jorgenson¹ built the first UPLC with 1.5 μm silica. However, the physical size of this UPLC was very large. In 2004, a commercial UPLC was introduced by Waters Inc.⁴ Nowadays, UPLC with pressures up to 20000 psi are available. Nevertheless, nearly all of these instruments are limited to laboratory use. Little effort has been made to miniaturize UPLC. A compact gradient LC system with an LED detector was reported⁵. The pressure generated only reaches up to 8000 psi⁵ that is below the typical pressure (˜15000 psi) of a laboratory UPLC.

Most commercial UPLC instruments can only operate with nanoflow rate. For this invention, a portable UPLC equipped with both isocratic and gradient elution was developed. The mobile phase flow can be adjusted from the nanoliter to the microliter region. The pressure from the pumps can reach up to 16,000 psi. An UV LED coupled with an optical fiber was used to enhance sensitivity and reduce the size and the weight of the whole device. The option of using a conventional detector with a discharge UV lamp and a grating is also kept.

### 2. Portable HPLC

Although little development on commercial portable UPLC has been reported, several commercial portable HPLC instruments have been on the market. Some specific features for developing portable HPLC can be good references for developing portable UPLC. A HPLC is typically made of four major components. They are (1) an injection system (2) an eluent pump to produce a specific flow rate (3) a column to separate the chemicals in the sample and (4) a detector to identify and quantify the eluted chemical.

Improvement of the above 4 items under high pressure is the key to have a successful portable UPLC. Six-port valve injection devices have been widely used in LC systems to introduce the sample without interrupting the flow of mobile phase flow. Since a six-port valve can stand the pressure of UPLC, we apply a six-port valve for our portable UPLC.

Piston pumps are often used in present LC. The main disadvantage is pulsed flow. Gradient elution LC is usually developed with either multiple pumps for different solvents or a single pump to drive a plug of fluid before mixing. For our portable UPLC, we use binary pump to achieve stable and continuous flow.

The decrease of particle size in the column can led to a better column efficiency. Although this approach improves the resolution, it needs high backpressures. We applied silica column to obtain the pressure meeting the need of UPLC.

Absorbance detectors are broadly used in portable HPLC due to the ease of miniaturization. For our portable UPLC, we coupled LED light source with optical fiber to increase the optical absorption path to increase the detection sensitivity.

### BRIEF DESCRIPTION OF THE DRAWINGS

FIG. 1: This figure depicts a schematic of a portable ultra-performance liquid chromatography (pUPLC) apparatus according to the present invention. The apparatus may include carrier reservoirs 1, an on-line degassing system 2, four linear stepping pumps 3, two PEEK Y-connectors 4, two stainless steel tees 5, a solvent mixer 6, a pressure transducer 7, a sample injector 8, a sample loop 9, a high pressure six-port valve 10, a column 11, and a detector system 12. The schematic diagrams show the high pressure six-port valve 10 switching; the left diagram depicts sample injection, and the right diagram shows sample aspiration.

FIG. 2: This schematic depicts a detector system 12 in FIG. 1, an embodiment of the present invention. The detector system can include a LED light source or a deuterium lamp 100, two quartz windows 110, a flow cell 120, a photodiode or UV spectrometer 130, two quartz ball lens 140, and an optical fiber 150.

FIG. 3: This figure illustrates a schematic of an embodiment of an autosampler according to the present invention. The autosampler may include a sampling needle 50, a wash solvent 51, a sample vial 52, an autosampler syringe pump 53, a syringe Y shape valve 70, an xyz axis linear motor 71, and a sample plate 72.

FIG. 4: This figure shows a schematic of an embodiment of UPLC connected to autosampler of this invention. The schematic diagram shows a six-port valve switch, with the sample injection on the left and sample aspiration on the right. The high pressure six-port valve has six ports 10: port 1 connect to the autosampler sampling needle 50, port 2, 5 connect to the sample loop 9 (see FIG. 1), port 3 connect to the portable UPLC system 1, 2, 3, 4, 5, 6, 7 (see FIG. 1), port 4 connect to the column 11, port 6 connect to the autosampler syringe pump 53.

FIG. 5: This figure shows the graph of the UPLC system pressure stable up to 10000 psi.

FIG. 6: This figure shows a photo for the portable UPLC with autosampler and assembled instrument.

FIG. 7: This figure shows the concentration setting of the system. The x-axis represents time and the y-axis represents acetone concentration.

FIG. 8: This figure shows the UV absorption spectrum. The x-axis represents time and the y-axis represents the light absorption at 270 nm by acetone.

FIG. 9: Detection of Amphetamine (AM); Good linear relationship is obtained with sample concentrations at 0.25 ug/ml, 0.5 ug/ml, 1 μg/ml, 2.5 ug/ml. Solvent used is H₂O Sensitivity reaches the level of part per billion (ppb).

FIG. 10: Detection of 3,4-Methylenedioxyamphetamine (MDA) Good linear relationship is obtained with sample concentrations at 0.5 ug/ml, 1 μg/ml, 2.5 ug/ml. Solvent is H₂O Sensitivity reaches the level of part per billion (ppb).

FIG. 11: Detection of Methamphetamine (MA) Good linear relationship is obtained with sample concentrations at 0.5 ug/ml, 1 μg/ml, 2.5 ug/ml. Solvent used is H₂O. Sensitivity can reach the level of part per billion (ppb).

FIG. 12: Detection of 3,4-Methylenedioxymethamphetamine (MDMA). Good linear relationship is obtained with sample concentrations at 0.5 ug/ml, 1 μg/ml, 2.5 ug/ml. Solvent used is H₂O. Sensitivity reaches the level of part per billion (ppb).

FIG. 13: Detection of 3,4-Methylenedioxyethylamphetamine (MDEA). Good linear relationship is obtained with sample concentrations at 0.5 ug/ml, 1 μg/ml, 2.5 ug/ml. Solvent used is H₂O. Sensitivity reaches the level of part per billion (ppb).

FIG. 14: Detection of mixtures of Amphetamine (AM); 3,4-Methylenedioxyamphetamine (MDA); Methamphetamine (MA); 3,4-Methylenedioxymethamphetamine (MDMA); and 3,4-Methylenedioxyethylamphetamine (MDEA). The concentration of each chemical is 0.5 ug/ml.

FIG. 15: Detection of p-Hydroxybenzoic acid (PHBA) Good linear relationship is obtained with sample concentrations at 2 ppm, 4 ppm and 6 ppm. Solvent used is H₂O. Sensitivity reaches the level of one part per million (ppm).

FIG. 16: Detection of phenol. Good linear relationship is obtained with sample concentrations at 20 ppm, 40 ppm and 60 ppm. Solvent used is H₂O. Sensitivity reaches the level of ten parts per million.

FIG. 17: Detection of 4-Hydroxyisophthalic acid (4HIPA). Good linear relationship is obtained with sample concentrations at 1.25 ppm, 2.5 ppm and 3.125 ppm. Solvent used is H₂O. Sensitivity reaches the level of 1 ppm.

FIG. 18: Detection of Salicylic acid (SA). Good linear relationship is obtained with sample concentrations at 2 ppm, 4 ppm and 6 ppm. Solvent used is H₂O. Sensitivity reaches the level of 1 ppm.

FIG. 19: Detection of mixtures of PHBA-5 ppm, Phenol-50 ppm, 4HIPA-3.125 ppm, SA-5 ppm.

FIG. 20: Detection of pure acetone.

FIG. 21: Detection of acetone-DNPH complex. The concentrations of acetone-DNPH are at 10 ppb, 20 ppb, 40 ppb, 60 ppb, 80 ppb, and 100 ppb respectively. The sensitivity reaches ppb level.

### DETAILED DESCRIPTION OF THE INVENTION

### Gradient Elution

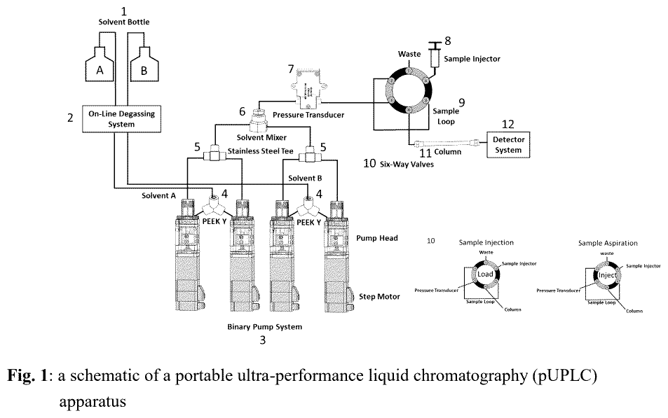

In this invention, we take high precision motors with modifications to make them as linear motors. The special advantage is to make mobile phase flow near constant. Four motors with binary pump to achieve continuous gradient elution. Two sets of motors were used to pump two different mobile phase solvents (A, B in FIG. 1, 1). Both flows are going to be mixed in solvent mixer (FIG. 1,6). The composition of different solvents can be varied with time to achieve different ratios of A and B so that gradient elusion can be achieved.

The mixing process was pursued under high pressure. In general, the ratio can be kept more precise than the mixing under lower pressure. In addition, two linear motors were combined as one set with synchronization to keep constant mobile phase flow. With this approach, a very stable gradient elution was achieved. If isocratic elusion is preferred, two mobile phase flow for two different solvents are kept constant. We set isocratic elusion as a special case of gradient elusion.

FIG. 7 is the test of solvent mixing for gradient elusion. Solvent A is high purity water and solvent B is 0.2% acetone in water. A program was developed to control the operation of the six-port valve. To start the operation, the six-port valve was switched from “load” into “inject. Then two sets of motors were applied to push two separate mobile phases to mix these two solvents mixed in the solvent mixer (FIG. 1; 6). Mobile phase subsequently moves into port 2 and 5 from port 3 then into Stainless Steel Union Connector (FIG. 1; 11).

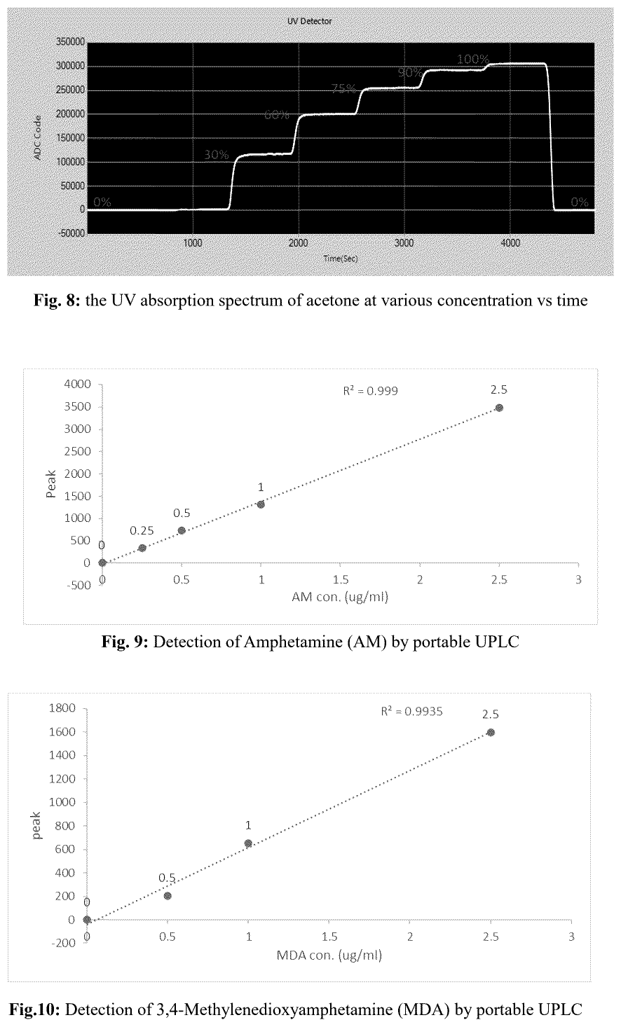

The light source used to take data in FIG. 8 was a deuterium lamp with the wavelength selection of 270 nm. A grating was used to obtain the wavelength selection. During the gradient elusion, the solvent in B started with 0.2% acetone and gradually increasing the concentration of acetone. Experimental result is shown in FIG. 8. In FIG. 7, the x-axis represents time and the y-axis represents acetone concentration. FIG. 7 is a conceptual explanation. In FIG. 8 the x-axis again represents time but the y-axis represents the light absorption at 270 nm by acetone.

### Optical Fiber Flow Cell

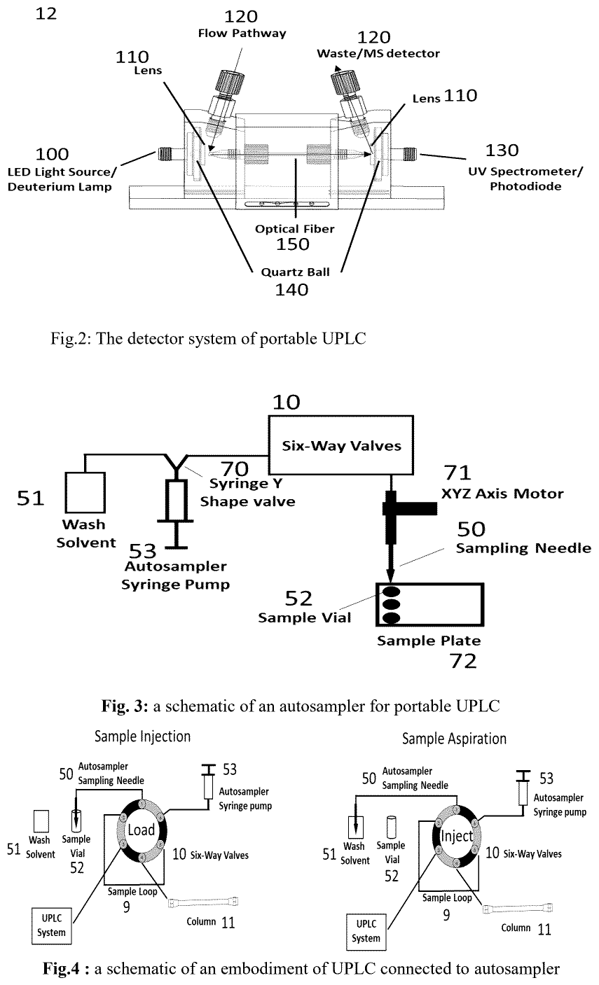

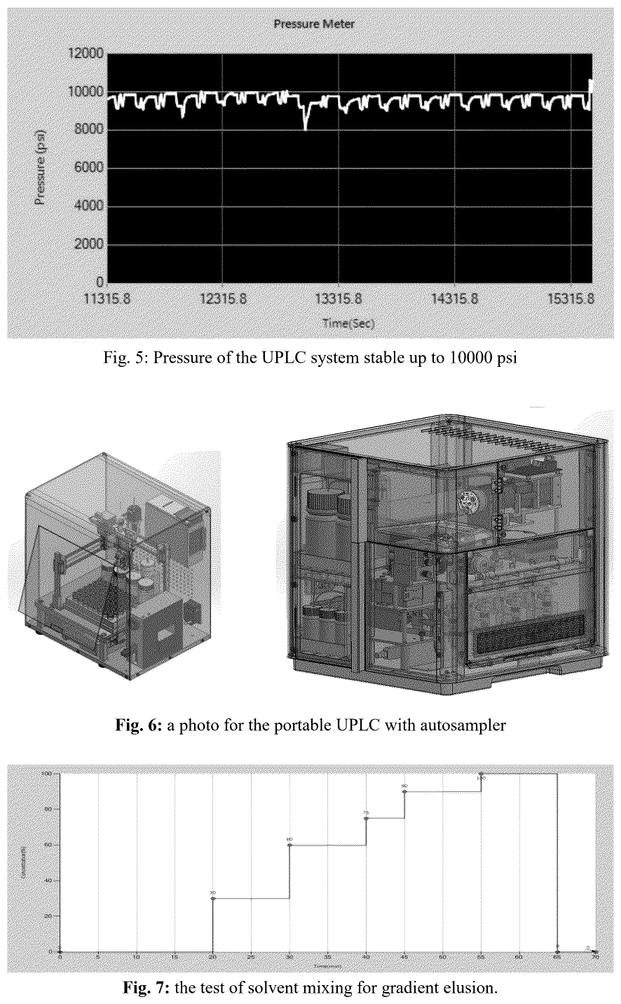

In this invention, a capillary fiber (FIG. 2, 150) was used as the sample flow cell. The use of optical fiber has the special advantage of increasing the fiber length, which enhances absorption and improves detection sensitivity. According to Beer's law, A (Absorbance)=ε(molar absorptivity)×b(path length)×(concentration), the absorbance (A) is proportional to the molar absorptivity (ε), path length (b), and concentration (c) of the sample. As absorptivity is linearly dependent on optical path, the use of optical fiber can significantly improve detection sensitivity.

The light source can be a monochromatic light source, such as a light-emitting diode (LED) or a diode laser. However, diode lasers are currently expensive, and their emitting wavelengths are difficult to reach the deep UV region. Therefore, we used LEDs for most of our work. With further technological advancements in the future, laser diodes could become a viable alternative. The LED has several advantages, including its small size, low cost, high intensity, and narrow bandwidth. However, it has two main disadvantages: (1) its wavelength is longer than 220 nm at present, which may not be suitable for certain compounds, and (2) multiple LEDs may be required since different compounds have different absorption bands.

In our invention, we employed a modular design that allows for the use of either LEDs or conventional discharge light sources, such as krypton or hydrogen or deuterium discharge lamps. To obtain monochromatic light, a grating is usually needed. The special advantage of the configuration of a discharge light with a grating is that deep UV can be obtained. However, this approach also has two main disadvantages: (1) it is expensive and (2) it is bulky. Most commercial UPLCs are equipped with a discharge light source and a grating.

### EXAMPLES

In this invention, sample injection can be achieved by either manual injection or an autosampler. The sample is injected into port 4 of the six-port valve (FIG. 1, 10), and the sample loop is used to control the quantity of sample to be injected. Then, the sample is mixed with the mobile phase solvents in the solvent mixer (FIG. 1, 6). After mixing, the mobile phase solution is switched from port 3 in the six-port valve to ports 2 and 5. Then, the sample with eluted solvents is sent into the column. Chemicals in the sample then have interactions with the particles as stationary phase. Various chemicals will be eluted out at different times to go into the optical fiber flow cell for absorption measurements. The detector can be an LED or discharge light source with a grating, as described in the above sections.

The following are some examples of how we used this invention for the detection of samples.

Data on detection of illegal drugs:

Experimental conditions for UPLC; Column: C18, LC Column dimension: 150×0.3 mm; Sample diluted in H₂O
Mobile phase: A 0.1% Phosphoric acid in H₂O

B 0.1% Phosphoric acid in ACN

Flow rate: 15 ul/min; Injection: 5 ul; Detection: UV 214 nm
Temperature: 40° C.; Flow cell optical fiber: 70 mm, ID100 μm gradient condition: 0-3 min 0% B; 3-10 min 10% B; 10-12 min 0% B.

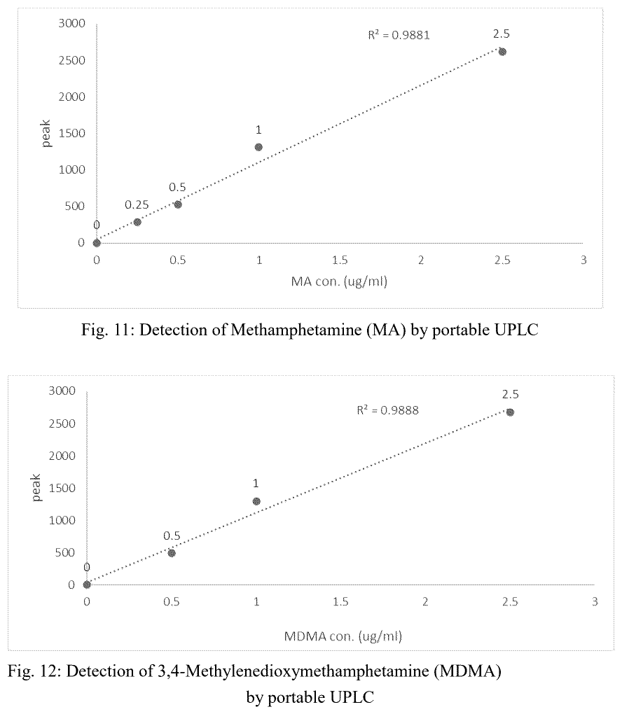

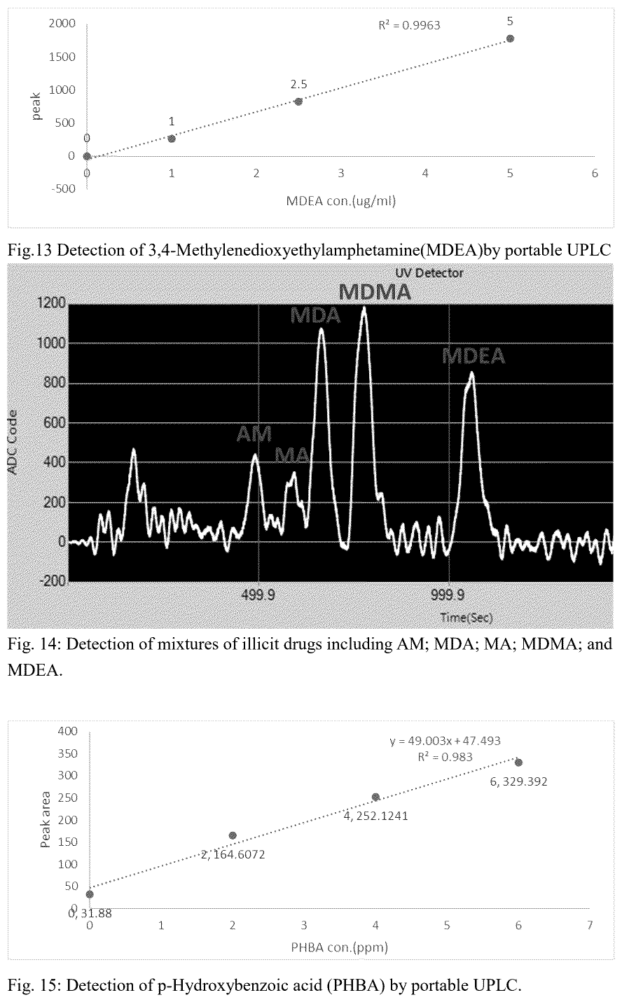

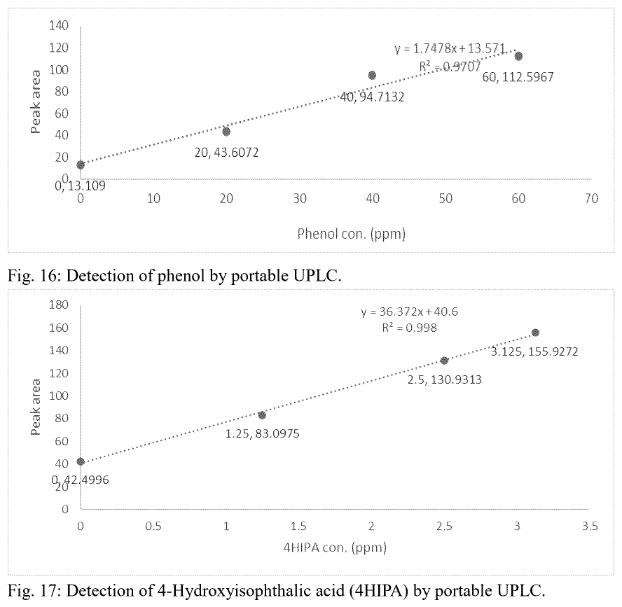

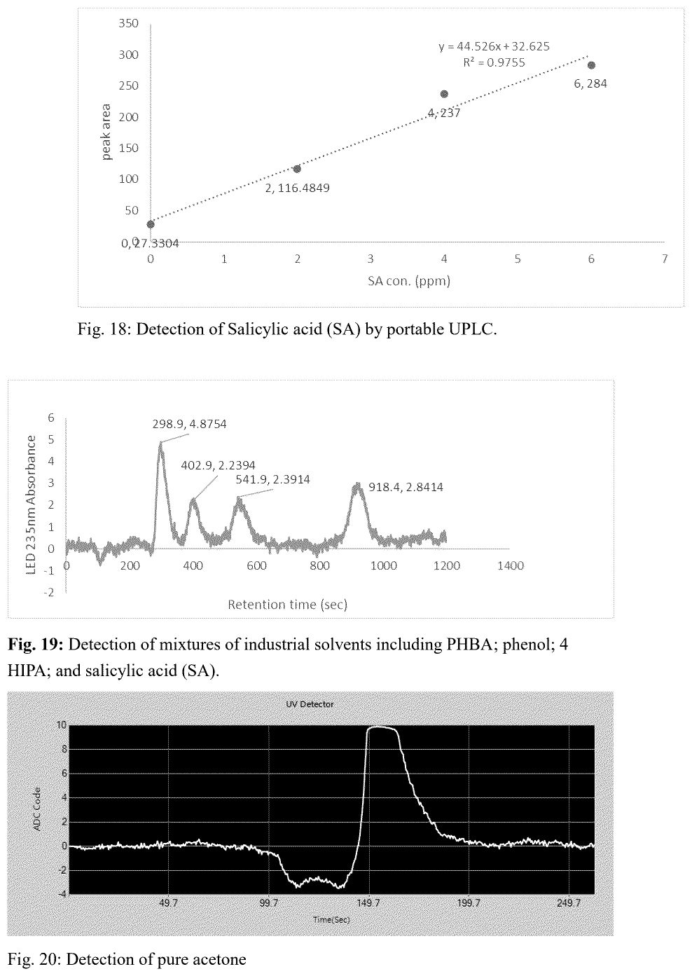

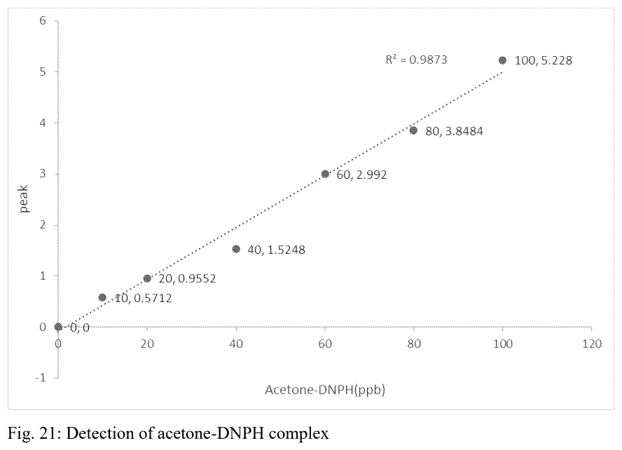

Data for the detection of amphetamine (AM) (FIG. 9); 3,4-Methylenedioxyamphetamine (MDA) (FIG. 10); Methamphetamine (MA) (FIG. 11); 3,4-Methylenedioxymethamphetamine (MDMA) (FIG. 12); and 3,4-Methylenedioxyethylamphetamine (MDEA) (FIG. 13) are obtained.

Due to the high sensitivity and the capability of in-situ real-time analysis, this instrument can be used for drug detection for both materials and human samples containing illegal drugs. Recently, some foods with illegal drug additives have been broadly distributed under the black market. They include instant coffee, soft drinks, chocolate bar and tea. This device can be used to detect these illegal materials without the need to send to big laboratories for analysis. This device can also be used for drug detection in human fluid samples such as urine or saliva or sweat.

Data on some industrial chemicals were obtained: Experimental conditions were set as following:
Column: Synergi™ 4 μm Hydro-RP 80 Å, LC Column 150x 0.3 mm, Capillary
Mobile phase: 0.01N H₃PO₄: MeOH: ACN=67:21:12 Sample diluted in H₂O.
Flow rate: 15 ul/min; Injection: 5 ul; Detector: LED at 235 nm.
Flow cell: optical fiber; 60 mm, ID100 μm. For many industrial chemicals, the detection sensitivity can reach to ppm or ppb.

Data on acetone and acetone-modified compounds Experimental conditions:
Column: Kinetex, C18; LC Column 50 mm (L)×0.3 mm (ID), 2.6 μm (particle size); Mobile phase: 50% MeOH+0.1% FA. Sample diluted in H₂O; Isocratic elution; Flow rate: 15 ul/min; Injection: 5 ul; Detector: LED at 365 nm

### Acetone

The main reason for derivatizing acetone is that it does not adsorb on the solid phase particles in a C18 column. Therefore, if acetone is directly analyzed as a sample, it will be eluted out by the mobile phase solvent after passing through the column. Therefore, acetone cannot be distinguished from other chemicals that are not bounded onto solid phase particle either. However, if acetone is derivatized with DNPH, the resulting derivative, DNPH-acetone, can be adsorbed on a C18 column and has absorbance at a wavelength of 365 nm under UV detection. Hence, this method can be used for detecting low level of acetone.

It is understood that this invention is not limited to the particular methodology, protocols, materials and reagents described, as these may vary. It is also to be understood that the terminology used herein is for the purpose of describing particular embodiments only and is not intended to limit the scope of the present invention, which will be encompassed by the appended claims.

It must be noted that as used herein and in the appended claims, the singular forms “a”, “an”, and “the” include plural reference unless the context clearly dictates otherwise. As well, the term “a” (or “an” “one” and “at least one”) can be used interchangeably herein.

Without further elaboration, it is believed that one skilled in art can, based on the above description, utilize the present invention to its fullest extent. The following specific embodiments are, therefore, to be considered as merely illustrative, and not limitative of the remainder of the disclosure in any way whatsoever.

All of the features disclosed in this specification may be combined in any combination. Each feature disclosed in this specification may be replaced by an alternative feature serving the same, equivalent, or similar purpose.

What is claimed:

1. An apparatus comprising:
a. a sample introduction system;
b. a solvent/solution mixing and transferring system;
c. a column with stationary phase for separation of different chemicals through elution;
d. a detector for the detection of eluted chemicals;
wherein the apparatus is configured to achieve the function of chemical separation of an ultra-high performance liquid chromatography.

2. In claim 1, all major components; including valves, connection tubing, pumps, transducers stand up the pressure of at least 15,000 psi with the range from 8000 psi to 20000 psi.

3. In claim 1, the size of the apparatus is less than 2 ft³ and the overall weight is less than 30 Kg.

4. In claim 1, The apparatus is equipped with on-line degas device for solvent introduction to reduce gas bubble formation, a six-port valve for mobile phase solvents mixing, sample injection, and sample delivery to LC column.

5. In claim 1, the elution motor design is to involve the use of linear step motor to achieve broad range of mobile phase input and to keep the mobile phase stable; with the range covering 2 nanoliter to 900 microliter.

6. In claim 5, combination of linear motors to give the elution to achieve the capability of performing isocratic elution or gradient elution.

7. In claim 1, column for separation is any commercially available column for liquid chromatography including (1) reverse phase columns: These columns are packed with nonpolar stationary phases (such as C18, C8, C4,) bonded to the silica surface, (2) normal phase columns: polar stationary phases (such as silica) and nonpolar mobile phases, (3) size exclusion columns, (4) affinity columns, (5) hydrophobic interaction columns, (6) chiral columns and (7) ion exchange columns.

8. In claim 1, the spectrum meter detector is with any UV-visible light sources such as hydrogen and rare gas discharge light sources and absorption measurement is used as quantitative determination.

9. In claim 1, the spectrum meter detector is with a VUV (vacuum ultraviolet) source such as argon-fluoride laser, helium-fluoride laser, helium or neon or argon discharge light source.

10. In claim 1, the spectrum meter detector can be easily removed and replaced with a LED detector.

11. In claim 1, the eluted chemicals go through an optical fiber with high reflection of UV light and a LED (light emitting diode) or a diode laser in UV region is used as light source for absorption measurements.

12. In claim 11, the length of optical fiber is from 5 cm to 3000 cm, The reflectivity for the light source is higher than 50% but preferred to be higher than 90%.

13. In claim 11, LED or diode laser beam is shined into the fiber for a long optical path or cross the optical fiber perpendicularly.

14. In claim 1, the sample input is either manual or by the autosampler, The autosampler is easily connected or disconnected from UPLC, During transportation, both UPLC and autosampler are portable.

15. In claim 1, this portable UPLC is connected to a different detector for detection when the original spectrum/LED/Diode laser detector is removed and these detectors include (1) FTIR (Fourier Transform infrared spectrometer), (2) Raman spectrometer (3) electric conductance and (4) mass spectrometer.

16. In claim 1, this portable UPLC can be connected to a mass spectrometer for detection when the original spectrum/LED/Diode laser detector is removed and different types of mass spectrometers include (1) quadrupole (2) triple-quad (3) ORBI-trap (4) quadrupole ion-trap (5) linear ion trap (6) time-of-flight (7) Fourier transform ion cyclotron (FTICR) (8) magnet sector.

17. In claim 1, this apparatus can be used to analyze chemical and biochemical compounds that can be analyzed by a laboratory UPLC.

18. In claim 1, this apparatus can be used to detect trace chemicals with/without chemical modifications such as the example of detecting acetone in water at part per million (ppm) to part per billion (ppb) with chemical modifications.

19. In claim 1, this apparatus is capable to do in-situ and real-time detection for illegal drugs as powder form by itself, illegal drugs in foods as additive, or in human fluids such as illegal drugs and their metabolites in urine, blood, saliva and sweat.

20. In claim 1, this apparatus is used to do in-situ and real-time detection of photoresist chemicals used in semiconductor chip manufacture.

21. A method for performing ultra-performance liquid chromatography (UPLC) comprising:
a. sample introduction process;
b. solvent/solution mixing and transferring processes;
c. using column for separation of different chemicals through elution;
d. the detection of eluted chemicals;
wherein the apparatus is configured to achieve the function of chemical separation of an ultra-high performance liquid chromatography.

22. In the method of claim 21, the method uses on-line degas device for solvent introduction to reduce gas bubble formation, a six-port valve is used for mobile phase solvents mixing, sample injection, and sample delivery to LC column.

23. In claim 20, the elution motor design to involve the use of linear step motor to achieve broad range of mobile phase input and to keep the mobile phase stable and the range covers 2 nanoliter to 900 microliter.

24. In claim 21, combination of linear motors to give the elution to achieve the capability of performing isocratic elution or gradient elution.

25. In claim 21, column used for separation can be any commonly used column for liquid chromatography including (1) reverse phase columns: These columns are packed with nonpolar stationary phases (such as C18, C8, C4,) bonded to the silica surface, (2) normal phase columns: polar stationary phases (such as silica) and nonpolar mobile phases, (3) size exclusion columns, (4) affinity columns, (5) hydrophobic interaction columns, (6) chiral columns and (7) ion exchange columns.

26. In claim 21, the spectrum meter detector is with any UV-visible light sources such as hydrogen and rare gas discharge light sources and absorption measurement as quantitative determination.

27. In claim 21, the spectrum meter detector is with a VUV (vacuum ultraviolet) source such as argon-fluoride laser, helium-fluoride laser, helium or neon or argon discharge light source.

28. In claim 21, the spectrum meter detector can be easily removed and replaced with a LED detector.

29. In claim 21, the eluted chemicals go through an optical fiber with high reflection of UV light and a LED (light emitting diode) or a diode laser in UV region is used as light source for absorption measurements.

30. In claim 29, the length of optical fiber is from 5 cm to 3000 cm, The reflectivity for the light source is higher than 50% but preferred to be higher than 90%.

31. In claim 21, LED or diode laser beam is shined into the fiber for a long optical path or cross the optical fiber perpendicularly.

32. In claim 21, the sample input can be either manual or by the autosampler and the autosampler is connected or disconnected from UPLC.

33. In claim 21, detection can be achieved by a different detector when the original spectrum/LED/Diode laser detector is removed and these detectors include (1) FTIR (Fourier Transform infrared spectrometer), (2) Raman spectrometer (3) electric conductance and (4) mass spectrometer.

34. In claim 21, the eluted chemicals can be connected to a mass spectrometer for detection when the original spectrum/LED/Diode laser detector is removed with most different types of mass spectrometers including (1) quadrupole (2) triple-quad (3) ORBI-trap (4) quadrupole ion-trap (5) linear ion trap (6) time-of-flight (7) Fourier transform ion cyclotron (FTICR) (8) magnet sector.

35. In claim 21, this method is used to analyze chemical and biochemical compounds that can be analyzed by a laboratory UPLC.

36. In claim 20, this method is used to detect trace chemicals with chemical modifications such as the example of detecting acetone in water at part per million (ppm) to part per billion (ppb) with chemical modifications, Selected chemicals can possibly be enriched to increase detection sensitivity to ppt (part per trillion) level.

37. In claim 21, this method is used to do in-situ and real-time detection for illegal drugs as powder form by itself, illegal drugs in foods as additive, or in human fluids such as these illegal drugs and their metabolites in urine, blood, saliva and sweat.

38. In claim 21, this method is used to do in-situ and real-time detection of photoresist chemicals.
